(19) United States
(12) Patent Application Publication
(10) Pub. No.: US 2017/0188103 A1
(43) Pub. Date: Jun. 29, 2017

(54) METHOD AND DEVICE FOR VIDEO RECOMMENDATION BASED ON FACE RECOGNITION

(71) Applicants: Le Holdings (Beijing) Co., Ltd., Beijing (CN); Le Shi Zhi Xin Electronic Technology (Tianjin) Limited, Binhai New Area (CN)

(72) Inventor: Feng Pan, Binhai New Area (CN)

(21) Appl. No.: 15/240,195

(22) Filed: Aug. 18, 2016

Related U.S. Application Data
(63) Continuation of application No. PCT/CN2016/089580, filed on Jul. 10, 2016.

(30) Foreign Application Priority Data
Dec. 29, 2015 (CN) 201511014705.X

(51) Int. Cl. H04N 21/466; H04N 21/442; H04N 21/25; G06Q 30/02; H04N 21/45; H04N 21/845; H04N 21/475; G06K 9/00; H04L 29/08; H04N 21/81

(52) U.S. Cl. CPC H04N 21/4668; H04L 67/22; H04N 21/44218; H04N 21/25; H04N 21/812; H04N 21/4532; H04N 21/8456; H04N 21/475; G06K 9/00228; G06Q 30/0272

(57) ABSTRACT

Some embodiments of this application disclose a video recommendation method and apparatus based on face recognition. A face detection process is initiated, and face data is acquired; identity information of a user is acquired in a preset face and user table according to the face data, where the face and user table stores a correspondence between face data and identity information of each user; and the acquired identity information is uploaded to a server, and a video file that is recommended according to a watching history of the user is received from the server. Therefore, the video recommendation method and apparatus based on face recognition resolve the problem that when all family members watch videos on a smart television by using a same account, recommending a video in which a family member is interested cannot be implemented for each family member.

### CROSS-REFERENCE TO RELATED APPLICATIONS

The present disclosure claims priority to Chinese Patent Application No. 201511014705.X, filed with the Chinese Patent Office on Dec. 29, 2015 and entitled “VIDEO RECOMMENDATION METHOD AND APPARATUS BASED ON FACE RECOGNITION”, which is incorporated herein by reference in its entirety.

### TECHNICAL FIELD

The present disclosure relates to the field of media communication, and in particular, to a video recommendation method and apparatus based on face recognition.

### BACKGROUND

Nowadays, the smart television is an intelligent multimedia terminal that emerges with the trend of televisions developing towards high definition, networking, and intelligence, and is equipped with capabilities of obtaining program content via many channels such as the Internet, a video device, and a computer, and presenting content that is most needed by a consumer on a screen through an integrated operation interface that is simple and easy to use.

Various video playing websites and applications can recommend videos in which a user is interested according to a watching habit of the user, which reduces a search time of the user, and improves user experience. As an entry for watching videos by an entire family, often only one member account is needed for the entire family to watch videos, and it is not needed for each family member to have a member account and pay a membership fee, and due to specialty of such a case, according to existing recommendation algorithms, recommending videos in which a family member is interested cannot be implemented for each family member.

### SUMMARY

In view of this, an objective of some embodiments of the present disclosure is to provide a video recommendation method and apparatus based on face recognition, which resolve the problem that when all family members watch videos on a smart television by using a same account, recommending a video in which a family member is interested cannot be implemented for each family member.

Based on the foregoing objective, the video recommendation method based on face recognition provided in some embodiments of the present disclosure includes steps:

initiating a face detection process, and acquiring face data;

acquiring identity information of a user in a preset face and user table according to the face data, where the face and user table stores a correspondence between face data and identity information of each user; and

uploading the acquired identity information to a server, and receiving, from the server, a video file that is recommended according to a watching history of the user.

In an embodiment, the watching history of the user is obtained by using the following steps:

in a process of playing a video file, monitoring playing time length of the video file, and if it is monitored that the playing time length reaches a preset threshold, marking the video file as an effective watching history;

initiating the face detection process, and acquiring the face data;

acquiring the identity information of the user in the preset face and user table according to the face data; and

uploading the acquired identity information and the effective watching history to the server.

In an embodiment, in the process of playing the video file, it is determined whether the played video file is an advertisement video file; and

according to a determining result, if the played video file is an advertisement video file, the playing time length of the video file is not monitored; and if the played video file is not an advertisement video file, the playing time length of the video file is monitored.

In an embodiment, the playing time length of the video file is monitored, and if it is monitored that the playing time length reaches the preset threshold,

it is determined whether an advertisement video file is played during the playing time length; and

if an advertisement video file is played, playing time length of the advertisement video file is subtracted from the playing time length, and it is determined whether subtracted time length reaches a preset threshold, and if the subtracted time length reaches the preset threshold, the video file is marked as an effective watching history, otherwise the playing time length of the video file is continued to be monitored; and

if no advertisement video file is played, the video file is marked as an effective watching history.

In an embodiment, before the initiating the face detection process, an instruction, from the user, for logging into a smart television account is acquired, or an instruction that is triggered when the user clicks on a video file after logging into the smart television account is received.

In another aspect, some embodiments of the present disclosure further provide a video recommendation apparatus based on face recognition, including:

a face data acquisition unit, configured to initiate a face detection process and acquire face data;

an identity information acquisition unit, configured to acquire identity information of a user in a preset face and user table according to the face data, where the face and user table stores a correspondence between face data and identity information of each user; and

a video file recommendation unit, configured to upload the acquired identity information to a server, and receive, from the server, a video file that is recommended according to a watching history of the user.

In an embodiment, the apparatus further includes a watching history uploading unit, configured to:

in a process of playing a video file, monitor playing time length of the video file, and if it is monitored that the playing time length reaches a preset threshold, mark the video file as an effective watching history;

initiate the face detection process, and acquire the face data;

acquire the identity information of the user in the preset face and user table according to the face data; and

upload the acquired identity information and the effective watching history to the server.

In an embodiment, the watching history uploading unit is further configured to:

in the process of playing the video file, determine whether the played video file is an advertisement video file; and

according to a determining result, if the played video file is an advertisement video file, skip monitoring the playing time length of the video file; and if the played video file is not an advertisement video file, monitor the playing time length of the video file.

In an embodiment, the watching history uploading unit is further configured to:

monitor the playing time length of the video file, and if it is monitored that the playing time length reaches the preset threshold,

determine whether an advertisement video file is played during the playing time length; and

if an advertisement video file is played, subtract playing time length of the advertisement video file from the playing time length, and determine whether subtracted time length reaches a preset threshold, and if the subtracted time length reaches the preset threshold, mark the video file as an effective watching history, otherwise continue monitoring the playing time length of the video file; and

if no advertisement video file is played, mark the video file as an effective watching history.

In an embodiment, before initiating the face detection process, the face data acquisition unit acquires an instruction, from the user, for logging into a smart television account, or receives an instruction that is triggered when the user clicks on a video file after logging into the smart television account.

It can be seen from the foregoing description that, by means of the video recommendation method and apparatus based on face recognition provided in some embodiments of the present disclosure, personalized and accurate video recommendation for each of watching users using a same account is implemented, and quality of smart television video service is optimized.

### BRIEF DESCRIPTION OF THE DRAWINGS

FIG. 1 is a schematic flowchart of a video recommendation method based on face recognition according to an embodiment of the present disclosure;

FIG. 2 is a schematic flowchart of a video recommendation method based on face recognition according to a referable embodiment of the present disclosure;

FIG. 3 is a schematic structural diagram of a video recommendation apparatus based on face recognition according to some embodiments of the present disclosure; and

FIG. 4 is a schematic structural diagram of a video recommendation apparatus based on face recognition according to a referable embodiment of the present disclosure.

### DETAILED DESCRIPTION

To make the objectives, technical solutions, and advantages of some embodiments of the present disclosure clearer, some embodiments of the present disclosure are described in further detail in combination with specific embodiments with reference to the accompanying drawings.

According to the use status of smart televisions, after a family member logs into an account, only video files in which all family members are interested are recommended to the family member for watching, and video files based on watching preferences of only the family member cannot be recommended. To resolve this problem, in some embodiment of the present disclosure, from the perspective of a user, it is realized that the user desires that only video files in which the user is interested are recommended to the user. Therefore, an idea of some embodiments of the present disclosure is establishing interconnection among face recognition, video files, and personalized recommendation on a smart television.

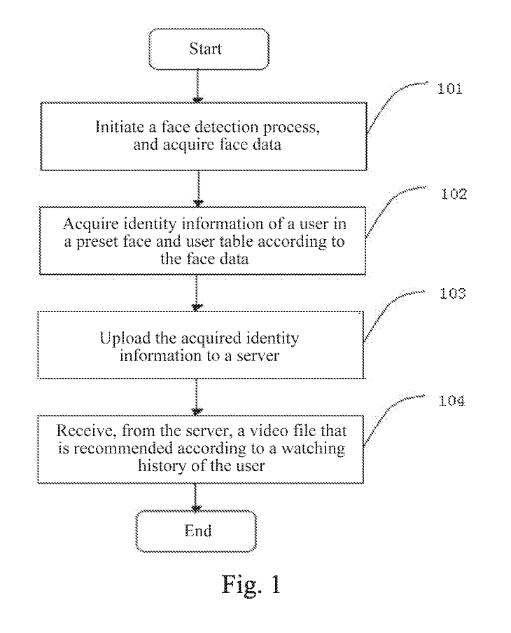

Refer to FIG. 1, which is a schematic flowchart of a video recommendation method based on face recognition according to an embodiment of the present disclosure. The video recommendation method based on face recognition includes:

Step 101: Initiate a face detection process, and acquire face data.

In this embodiment, after an instruction, from a user, for logging into a smart television account is acquired, the face detection process may be initiated. Alternatively, the face detection process may be initiated after an instruction that is triggered when the user clicks on a video file after logging into the smart television account is received.

The smart television account refers to an account for an entire family that is set on a smart television. First the user may log into the account through verification of the family account, then different users logging into the family account are recognized by initiating the face detection process. Thereby, multiple users sharing the same family account may be recognized.

In this embodiment, the face detection process is set to be resident in a system, and is a background process keeping running by default.

Step 102: Acquire identity information of a user in a preset face and user table according to the face data.

In this embodiment, the face and user table stores a correspondence between face data and identity information of each user. The identity information may include a user name, a password, a gender, an age, and the like.

It is to be noted that, before the identity information of the user is acquired in the preset face and user table, whether the identity information of the user exists in the preset face and user table may be determined according to the face data. If the identity information exists, the identity information is acquired, otherwise the identity information of the user corresponding to the face data is created in the face and user table. For example, a floating window may be popup for the user to set the identity information by himself/herself, and the set identity information and the face data are corresponded and stored into face and user table. Preferably, an updated face and user table is uploaded to a server.

In this embodiment, each family account is corresponding to a face and user table, where the face and user table stores a correspondence between face data and identity information of each user logging into the family account. Alternatively, the face and user table stores correspondences between face data and identity information of all users, which include correspondences between face data and identity information of users that undergo face detection after logging into a same family account, and also include correspondences between face data and identity information of users that undergo face detection after logging into different family accounts.

In this embodiment, when the face and user table stores the correspondences between the face data and the identity information of all the users, the face and user table may also store a family account identifier. That is, a family account identifier is further set in the correspondence between the face data and the identity information of each user, where family account identifiers of multiple users logging into a same family account are the same.

In addition, the face and user table may be stored locally, or may not be stored locally. However, whether the face and user table is stored locally or not, the face and user table is stored in the server end. Preferably, if the face and user table is not stored locally, the face and user table currently stored in the server may be obtained by sending a request to the server through a network by using a current local MAC address as a parameter.

Step 103: Upload the acquired identity information to a server.

In an embodiment, the identity information corresponding to the acquired face data in the face and user table may be uploaded to the server.

Step 104: Receive, from the server, a video file that is recommended according to a watching history of the user.

In this embodiment, the watching history of the user is obtained in the following manner: in a process of playing a video file, monitoring playing time length of the video file, and if it is monitored that the playing time length reaches a preset threshold, marking the video file as an effective watching history; Preferably, the preset threshold is three quarters of total time length of the video. The playing time length is a total time of an already played part of the video file. In addition, a reason for the case that the playing time length of the video file does not reach total time length of the video may be, for example, changing a channel or shutting down by the user.

Then the face detection process is initiated, and the face data is acquired. The identity information of the user in the preset face and user table is acquired according to the face data. Finally, the acquired identity information and the effective watching history are uploaded to the server.

In this embodiment, in the process of playing the video file, it is needed to determine whether the played video file is an advertisement video file. If the played video file is an advertisement video file, the playing time length of the video file is not monitored; and if the played video file is not an advertisement video file, the playing time length of the video file is monitored. Thereby, before the playing time length of the video file is monitored, the advertisement video file can be excluded, so that an effective watching history can be accurately marked, and monitoring efficiency can be improved maximally.

In this embodiment, when it is monitored that the playing time length reaches the preset threshold, it is determined whether an advertisement video file is played during the playing time length. If an advertisement video file is played, playing time length of the advertisement video file is subtracted from the playing time length. Then, it is determined whether subtracted time length reaches a preset threshold, and if the subtracted time length reaches the preset threshold, the video file is marked as an effective watching history, otherwise the playing time length of the video file is continued to be monitored. If no advertisement video file is played, the video file is marked as an effective watching history. It can be seen from this embodiment that, in some embodiments of the present disclosure, to effectively realize the effect that only a video file that is actually watched by a user is marked, played content that does not belong to the video file, for example, an advertisement video file during a playing process of the video file, needs to excluded from monitored time length.

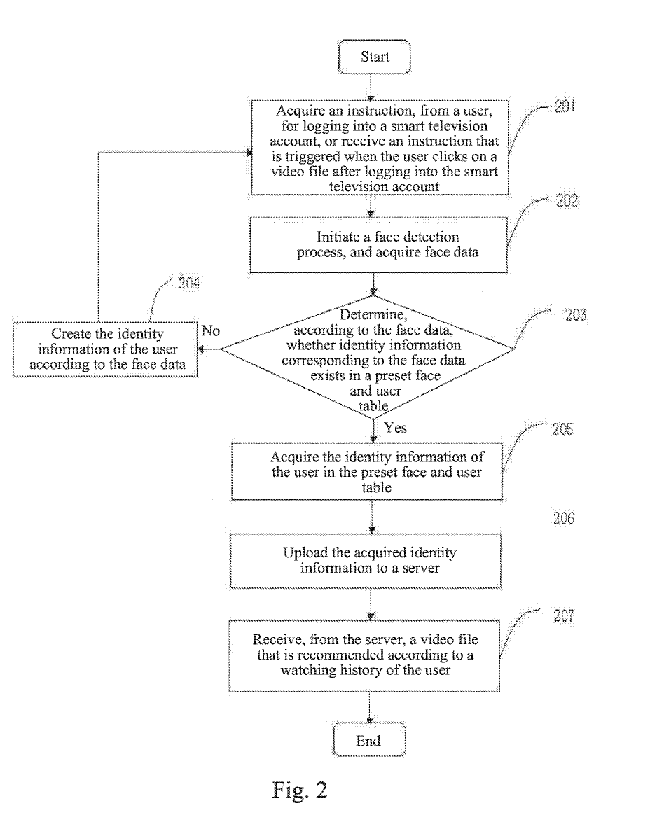

As a referable embodiment, referring to FIG. 2, the video recommendation method based on face recognition may specifically include the following steps.

Step 201: Acquire an instruction, from a user, for logging into a smart television account, or receive an instruction that is triggered when the user clicks on a video file after logging into the smart television account.

Step 202: Initiate a face detection process, and acquire face data.

Step 203: Determine, according to the face data, whether identity information corresponding to the face data exists in a preset face and user table. If the face data exists, proceed to step 205, otherwise proceed to step 204.

Step 204: Create the identity information of the user according to the face data. Then return to step 201.

Step 205: Acquire the identity information of the user in the preset face and user table. Then proceed to step 206.

Step 206: Upload the acquired identity information to a server.

Step 207: Receive, from the server, a video file that is recommended according to a watching history of the user.

It is also worth noting that, the watching history of the user may be obtained by using the following referable implementation process, which includes:

Step 1: In a process of playing a video file, determine whether the played video file is an advertisement video file, and if yes, proceed to step 2, otherwise proceed to step 3.

Step 2: Skip monitoring playing time length of the video file, and exit the process.

Step 3: Monitor playing time length of the video file, and proceed to step 4.

Step 4: If it is monitored that the playing time length reaches a preset threshold, determine whether an advertisement video file is played during the playing time length, and if an advertisement video file is played, proceed to step 5, otherwise proceed to step 7.

Step 5: Subtract playing time length of the advertisement video file from the playing time length, and proceed to step 6.

Step 6: Determine whether subtracted time length reaches a preset threshold, and if yes, proceed to step 7, otherwise return to step 3.

Step 7: Mark the video file as an effective watching history, and proceed to step 8.

Step 8: Initiate the face detection process, and acquire the face data.

Step 9: Acquire identity information of the user in a preset face and user table according to the face data.

Step 10: Upload the acquired identity information and the effective watching history to a server.

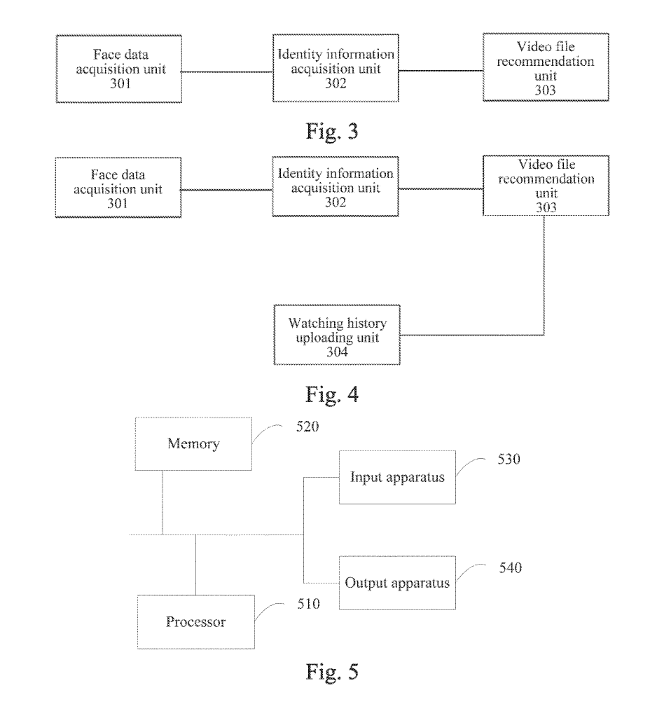

Some embodiments of the present disclosure further provide a video recommendation apparatus based on face recognition. As shown in FIG. 3, the video recommendation apparatus based on face recognition includes a face data acquisition unit 301, an identity information acquisition unit 302, and a video file recommendation unit 303 that are connected sequentially. The face data acquisition unit 301 is configured to initiate a face detection process and acquire face data. The identity information acquisition unit 302 is configured to acquire identity information of a user in a preset face and user table according to the face data. The face and user table stores a correspondence between face data and identity information of each user. The video file recommendation unit 303 is configured to upload the acquired identity information to a server, and receive, from the server, a video file that is recommended according to a watching history of the user.

In this embodiment, before initiating the face detection process, the face data acquisition unit 301 acquires an instruction, from the user, for logging into a smart television account, or receives an instruction that is triggered when the user clicks on a video file after logging into the smart television account.

In this embodiment, each family account is corresponding to a face and user table, where the face and user table stores a correspondence between face data and identity information of each user logging into the family account. Alternatively, the face and user table stores correspondences between face data and identity information of all users, which include correspondences between face data and identity information of users that undergo face detection after logging into a same family account, and also include correspondences between face data and identity information of users that undergo face detection after logging into different family accounts.

In addition, the face and user table may be stored locally, or may not be stored locally. However, whether the face and user table is stored locally or not, the face and user table is stored in the server end. Preferably, if the face and user table is not stored locally, the face and user table currently stored in the server may be obtained by sending a request to the server through a network by using a current local MAC address as a parameter.

As a referable embodiment of the video recommendation apparatus based on face recognition in the present disclosure, as shown in FIG. 4, the apparatus further includes a watching history uploading unit 304 connected to the video file recommendation unit 303. In a process of playing a video file, the watching history uploading unit 304 monitors playing time length of the video file, and if it is monitored that the playing time length reaches a preset threshold, marks the video file as an effective watching history. Preferably, the preset threshold is three quarters of total time length of the video.

Then the face detection process is initiated, and the face data is acquired. The identity information of the user in the preset face and user table is acquired according to the face data. Finally, the acquired identity information and the effective watching history are uploaded to the server.

In this embodiment, in the process of playing the video file, the watching history uploading unit 304 needs to determine whether the played video file is an advertisement video file. If the played video file is an advertisement video file, the playing time length of the video file is not monitored; and if the played video file is not an advertisement video file, the playing time length of the video file is monitored. Thereby, before the playing time length of the video file is monitored, the advertisement video file can be excluded, so that an effective watching history can be accurately marked, and monitoring efficiency can be improved maximally.

In this embodiment, when the watching history uploading unit 304 monitors that the playing time length reaches the preset threshold, the watching history uploading unit 304 determines whether an advertisement video file is played during the playing time length. If an advertisement video file is played, playing time length of the advertisement video file is subtracted from the playing time length. Then, it is determined whether subtracted time length reaches a preset threshold, and if the subtracted time length reaches the preset threshold, the video file is marked as an effective watching history, otherwise the playing time length of the video file is continued to be monitored. if no advertisement video file is played, mark the video file as an effective watching history.

It is to be noted that, specific implementation content for the video recommendation apparatus based on face recognition in some embodiments of the present disclosure has been described in detail in the foregoing video recommendation method based on face recognition, and therefore the repeated content is not described herein again.

To sum up, according to the video recommendation method and apparatus based on face recognition provided in some embodiments of the present disclosure, the problem of inflexibility of video recommendation services for a smart television is creatively resolved, and diversity of the recommendation services are achieved; recommending a video in which a user is interested can be implemented for each user watching videos; and finally, the entire video recommendation method and apparatus based on face recognition are compact and easy to implement.

It should be understood by a person of ordinary skill in the art that, what is described above is merely specific embodiments of the present disclosure, and is not intended to limit the present disclosure, and any modification, equivalent replacement, and improvement shall be included within the protection scope of the present disclosure without departing from the spirit and principle of the present disclosure.

1. A video recommendation method based on face recognition, applied to a terminal, comprising steps:
initiating a face detection process, and acquiring face data;
acquiring identity information of a user in a preset face and user table according to the face data, wherein the face and user table stores a correspondence between face data and identity information of each user; and
uploading the acquired identity information to a server, and receiving, from the server, a video file that is recommended according to a watching history of the user.

2. The method according to claim 1, wherein the watching history of the user is obtained by using the following steps:
in a process of playing a video file, monitoring playing time length of the video file, and if it is monitored that the playing time length reaches a preset threshold, marking the video file as an effective watching history;
initiating the face detection process, and acquiring the face data;
acquiring the identity information of the user in the preset face and user table according to the face data; and
uploading the acquired identity information and the effective watching history to the server.

3. The method according to claim 2, wherein in the process of playing the video file, it is determined whether the played video file is an advertisement video file; and
according to a determining result, if the played video file is an advertisement video file, the playing time length of the video file is not monitored; and if the played video file is not an advertisement video file, the playing time length of the video file is monitored.

4. The method according to claim 2, wherein the playing time length of the video file is monitored, and if it is monitored that the playing time length reaches the preset threshold,
it is determined whether an advertisement video file is played during the playing time length; and
if an advertisement video file is played, playing time length of the advertisement video file is subtracted from the playing time length, and it is determined whether subtracted time length reaches a preset threshold, and if the subtracted time length reaches the preset threshold, the video file is marked as an effective watching history, otherwise the playing time length of the video file is continued to be monitored; and
if no advertisement video file is played, the video file is marked as an effective watching history.

5. The method according to claim 1, wherein before the initiating the face detection process, an instruction, from the user, for logging into a smart television account is acquired, or an instruction that is triggered when the user clicks on a video file after logging into the smart television account is received.

6-10. (canceled)

11. A non-volatile computer storage medium, which stores computer executable instructions, that when executed by an electronic device, cause the electronic device to:
initiate a face detection process, and acquire face data;
acquire identity information of a user in a preset face and user table according to the face data, wherein the face and user table stores a correspondence between face data and identity information of each user; and
upload the acquired identity information to a server, and receive, from the server, a video file that is recommended according to a watching history of the user.

12. The non-volatile computer storage medium according to claim 11, wherein the watching history of the user is obtained cause the electronic device to:
in a process of playing a video file, monitor playing time length of the video file, and if it is monitored that the playing time length reaches a preset threshold, marking the video file as an effective watching history;
initiate the face detection process, and acquiring the face data;
acquire the identity information of the user in the preset face and user table according to the face data; and
upload the acquired identity information and the effective watching history to the server.

13. The non-volatile computer storage medium according to claim 12, wherein the instructions to play the video file, it is determined whether the played video file is an advertisement video file; and
according to a determining result, if the played video file is an advertisement video file, the playing time length of the video file is not monitored; and if the played video file is not an advertisement video file, the playing time length of the video file is monitored.

14. The non-volatile computer storage medium according to claim 12, wherein the playing time length of the video file is monitored, and if it is monitored that the playing time length reaches the preset threshold,
it is determined whether an advertisement video file is played during the playing time length; and
if an advertisement video file is played, playing time length of the advertisement video file is subtracted from the playing time length, and it is determined whether subtracted time length reaches a preset threshold, and if the subtracted time length reaches the preset threshold, the video file is marked as an effective watching history, otherwise the playing time length of the video file is continued to be monitored; and
if no advertisement video file is played, the video file is marked as an effective watching history.

15. The non-volatile computer storage medium according to claim 11, wherein before the instructions to initiate the face detection process, an instruction, from the user, for logging into a smart television account is acquired, or an instruction that is triggered when the user clicks on a video file after logging into the smart television account is received.

16. An electronic device, comprising:
at least one processor; and
a memory communicably communication with the at least one processor, wherein
the memory stores instructions executable by the at least one processor, wherein
execution of the instructions by the at least one processor causes the at least one processor to:
initiate a face detection process, and acquire face data;
acquire identity information of a user in a preset face and user table according to the face data, wherein the face and user table stores a correspondence between face data and identity information of each user; and
upload the acquired identity information to a server, and receive, from the server, a video file that is recommended according to a watching history of the user.

17. The electronic device according to claim 16, wherein the watching history of the user is obtained cause the at least one processor to:
in a process of playing a video file, monitor playing time length of the video file, and if it is monitored that the playing time length reaches a preset threshold, marking the video file as an effective watching history;
initiate the face detection process, and acquiring the face data;
acquire the identity information of the user in the preset face and user table according to the face data; and
upload the acquired identity information and the effective watching history to the server.

18. The electronic device according to claim 17, wherein the execution of the instructions to play the video file, it is determined whether the played video file is an advertisement video file; and
according to a determining result, if the played video file is an advertisement video file, the playing time length of the video file is not monitored; and if the played video file is not an advertisement video file, the playing time length of the video file is monitored.

19. The electronic device according to claim 17, wherein the playing time length of the video file is monitored, and if it is monitored that the playing time length reaches the preset threshold,
it is determined whether an advertisement video file is played during the playing time length; and
if an advertisement video file is played, playing time length of the advertisement video file is subtracted from the playing time length, and it is determined whether subtracted time length reaches a preset threshold, and if the subtracted time length reaches the preset threshold, the video file is marked as an effective watching history, otherwise the playing time length of the video file is continued to be monitored; and
if no advertisement video file is played, the video file is marked as an effective watching history.

20. The electronic device according to claim 16, wherein before the initiating the face detection process, an instruction, from the user, for logging into a smart television account is acquired, or an instruction that is triggered when the user clicks on a video file after logging into the smart television account is received.
